(19) United States
(12) Patent Application Publication
(10) Pub. No.: US 2009/0000466 A1
(43) Pub. Date: Jan. 1, 2009

(54) METHOD TO ACTIVELY TRIGGER A SERVO VALVE

(76) Inventors: Martin Boecker, Korschenbroich (DE); Heinz-Dieter Heitzer, Heinsberg (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 12/145,189

(22) Filed: Jun. 24, 2008

(30) Foreign Application Priority Data
Jun. 29, 2007 (DE) 10 2007 030 326.4

(51) Int. Cl. B62D 5/09; B62D 5/083

(52) U.S. Cl. 91/375 A; 137/625.21

(57) ABSTRACT

A method to actively trigger a servo valve of a hydraulic power steering system is disclosed herein. In the method, a present steering wheel torque is ascertained by a sensor. The method also includes the step of a desired rack-and-pinion force offset is specified. The method also includes the step of a desired steering wheel torque offset is specified. The method also includes the step of a desired shape of a power steering characteristic curve is specified. On the basis of the specified offset values, the ascertained steering wheel torque and the specified shape of the power steering characteristic curve, a setpoint is ascertained for a differential pressure at a hydraulic cylinder of the power steering system. Based on the steering wheel torque and on the setpoint for the differential pressure at the hydraulic cylinder, a setpoint is ascertained for a setting angle (φ) of a valve component. The method also includes the step of rotating an appropriate valve component of the servo valve until the setpoint of the setting angle of the valve component is reached.

### CROSS-REFERENCE TO RELATED APPLICATIONS

This application claims priority to German Patent Application No. 10 2007 030 326.4 filed Jun. 29, 2008, the disclosures of which are incorporated herein by reference in their entirety.

### BACKGROUND OF THE INVENTION

The invention relates to a method to trigger a servo valve of a hydraulic power steering system.

Servo valves are generally known as key components of hydraulic power steering systems that can provide steering assistance to the driver of a vehicle. The fundamental idea is—in response to a steering movement by the driver—to provide hydraulic assistance in order to reduce the steering wheel torque that has to be applied manually by the driver. In the meantime, however, power steering systems have been refined in such a way as to allow an active actuation of the steering, even independently of any steering movement on the part of the driver. In this manner, for example, brief power-assisted pulses can be generated for the driver or else special functions can be achieved such as driver-independent parking and automatic side wind compensation.

German utility model 20 2005 018 390 U1 describes such a servo valve for actively providing a superimposed torque. With the described servo valve, the valve sleeve and the output shaft are not non-rotatably connected but rather, are coupled to each other via a gear. When the gear is actuated by a drive, the valve sleeve and the output shaft are rotated relative to each other, as a result of which a driver-independent superimposed torque is generated.

It is an object of the invention to adapt the shape and/or position of a power steering characteristic curve in a situation-dependent manner by means of a simple, active triggering of the servo valve so that a desirable and uniformly pleasant steering feel is created for the driver.

### BRIEF SUMMARY OF THE INVENTION

According to the invention, this is achieved by a method to actively trigger a servo valve of a hydraulic power steering system, comprising the following steps:
a. a present steering wheel torque is ascertained by a sensor;
b. a desired rack-and-pinion force offset is specified;
c. a desired steering wheel torque offset is specified;
d. a desired shape of a power steering characteristic curve is specified;
e. on the basis of the specified offset values, the ascertained steering wheel torque and the specified shape of the power steering characteristic curve, a setpoint for a differential pressure at a hydraulic cylinder of the power steering system;
f. based on the steering wheel torque and on the setpoint for the differential pressure at the hydraulic cylinder, a setpoint is ascertained for a setting angle of a valve component; and
g. an appropriate valve component of the servo valve is rotated until the setpoint of the setting angle of the valve component is reached.

Due to this active rotation of the valve component as a function of the present steering wheel torque, the shape and/or position of the power steering characteristic curve can be influenced with little effort and consequently, a desired steering feel can be set. The term “offset” refers to force, torque or pressure specifications that are generated in the power steering system without the involvement of the driver. In a coordinate system in which the differential pressure at the hydraulic cylinder is plotted over the steering wheel torque, the power steering characteristic curve of the hydraulic power steering system that was originally centrosymmetrical to a coordinate origin is shifted due to the specification of such offset values. In this context, the offset for a rack-and-pinion force is selected, for example, such that external influences (e.g. side wind) are compensated for and are no longer perceptible to the driver. In contrast, a steering wheel torque that is present on the steering wheel is influenced by an appropriately selected torque offset such that the driver perceives a defined steering assistance, for example, to stabilize the vehicle.

In one embodiment, a coordinate transformation of the specified power steering characteristic curve is carried out in step e) using the specified offset values and the ascertained steering wheel torque, thus yielding the setpoint for the differential pressure at the hydraulic cylinder of the power steering system. Clearly, through this coordinate transformation, the specified power steering characteristic curve is shifted such that the specified offset values do not have a negative influence on the way the driver feels the steering.

Concretely, a pressure differential offset for the hydraulic cylinder of the power steering system can first be ascertained on the basis of the rack-and-pinion force offset and of the steering wheel torque offset, said pressure differential offset then entering into the coordinate transformation of the specified power steering characteristic curve.

The setting angle of the valve component is preferably calculated in step f) as the difference between a valve opening angle and a valve rotation angle, the valve opening angle being ascertained by means of an inverted valve characteristic curve of the servo valve on the basis of the setpoint for the differential pressure at the hydraulic cylinder, and the valve rotation angle being ascertained by means of a valve stiffness on the basis of the present steering wheel torque.

In one variant of the method, the desired shape of the power steering characteristic curve in step d) corresponds to a basic shape of the power steering characteristic curve at a constant valve component setting angle of 0°. Hence, in this case, the power steering characteristic curve retains its basic shape and is merely shifted during the further course of the process.

In another variant of the method, the desired shape of the power steering characteristic curve is freely defined in step d), as a result of which a relationship between the present steering wheel torque and the differential pressure at the hydraulic cylinder is specified, said relationship then entering into the calculation of the setpoint for the differential pressure at the hydraulic cylinder in step e). As a result, virtually any desired shaping of the power steering characteristic curve is possible. Once the desired shape of the characteristic curve has been achieved, the power steering characteristic curve can be shifted during the further course of the method such that, all in all, the desired steering feel is created for the driver. In this variant of the method, the setpoint for the setting angle of the valve component in step f) is made up of a partial angle that is dependent on the present steering wheel torque for shaping the power steering characteristic curve and of another partial angle for shifting the power steering characteristic curve.

Especially preferably, the valve component that is rotated in step g) is a valve sleeve of the servo valve. Devices for adjusting the valve sleeve are already known in the prior art and can be installed in hydraulic power steering systems with an acceptable amount of effort. Consequently, in this case, the setting angle of the valve component is also referred to as the valve sleeve setting angle.

The servo valve can include, for example, an input shaft, a valve sleeve that can be rotated relative to the input shaft, and an output shaft that can be rotated relative to the valve sleeve, an angle between the valve sleeve and the output shaft corresponding to the setting angle of the valve component.

Here, the valve sleeve and the output shaft are preferably coupled by a drive that continuously sets the setpoint for the setting angle of the valve component. The drive can especially be a hydraulic, electromagnetic or electromechanical drive.

In a variant of the method, a sensor is provided with which an actual value of the setting angle of the valve component is measured.

Preferably, in this variant of the method, a position regulator is also provided that readjusts the rotation of the valve component such that the measured actual value corresponds to the setpoint of the setting angle of the valve component. Compared to a simple (open-loop) control of the setting angle of the valve component, the desired rotation of the valve component can be set much more precisely by this (closed-loop) control of the setting angle of the valve component that takes place via an adjustment of setpoints and actual values.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows by way of example a power steering valve assembly whose servo valve can be triggered by the method according to the invention;

FIG. 2 shows a schematic flow diagram of the method according to the invention;

FIG. 3 shows a power steering characteristic curve before and after a coordinate transformation;

FIG. 4 shows a valve characteristic curve and an inverted valve characteristic curve of a servo valve;

FIG. 5 shows a comparison between a static and a dynamic valve component adjustment with reference to the example of the compensation of a rack-and-pinion force;

FIG. 6 shows a comparison between a static and a dynamic valve component adjustment with reference to the example of the generation of a steering torque offset;

FIG. 7 shows an example of the shaping of a power steering characteristic curve by means of a dynamic valve component adjustment;

FIG. 8 shows various power steering characteristic curves as well as a specified tolerance range; and

FIG. 9 shows a power steering characteristic curve with a hysteresis of varying width.

### DETAILED DESCRIPTION OF THE INVENTION

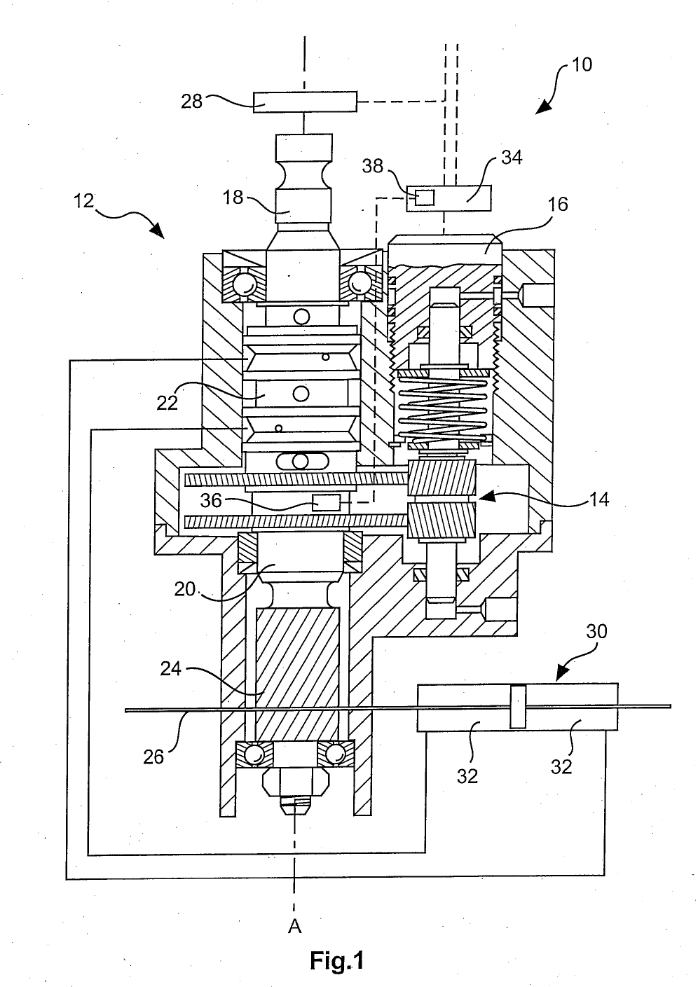

FIG. 1 shows a valve assembly 10 for a hydraulic power steering system in a vehicle. The valve assembly 10 has a servo valve 12, a gear 14 for adjusting two valve components of the servo valve 12 and a hydraulic drive 16 for the gear 14. The term valve components of the servo valve 12 refers, for example, to an input shaft 18, an output shaft 20 and a valve sleeve 22. Here, the input shaft 18 is connected non-rotatably in a known manner to a steering wheel and coupled via a torque rod (not shown here) to the output shaft 20. The output shaft 20 is provided with a pinion 24 that engages with a rack 26 that is part of a steering gear. A section of the input shaft 18 configured with control grooves is arranged in the valve sleeve 22. In FIG. 1, the valve sleeve 22 is not rigidly coupled to the output shaft 20 but rather is rotatably supported on it. To put it more precisely, the valve sleeve 22 is connected to the output shaft 20 by the gear 14 that is configured as a linear actuator. The linear actuator can be activated via the hydraulic drive 16 so that the output shaft 20 and the valve sleeve 22 rotate relative to each other. In case the gear 14 is not activated by the drive 16, the valve sleeve 22 and the output shaft 20 are held by the gear 14 non-rotatably relative to each other but they can rotate together around a valve axis A. As an alternative to the hydraulically driven linear actuator, it is, of course, also possible to use an electromechanical linear actuator or another suitable drive such as, for instance, a double action proportional magnet.

The angles between individual valve components are defined as follows:

An angle between the input shaft 18 and the valve sleeve 22 is referred to as a valve opening angle α. This angle ascertains the position of the cooperating control grooves of the input shaft 18 and the valve sleeve 22, thus defining the hydraulic flow in the servo valve 12.

An angle between the input shaft 18 and the output shaft 20 is referred to below as a valve rotation angle β. When a torque rod is used as the centering device, this valve rotation angle β corresponds to the angle by which the torque rod is rotated between its axial ends.

Finally, the angle between the output shaft 20 and the valve sleeve 22 is referred to as a setting angle φ of the valve component. The setting angle φ of the valve component is actively defined via the gear 14 by means of the drive 16.

The above-mentioned angles are defined here in such a way that the valve opening angle α, the valve rotation angle β and the setting angle φ of the valve component are each 0° in a hydraulic centre position of the servo valve 12, when the torque rod is not twisted, the drive 16 is deactivated and the vehicle is driving straight ahead with an unstressed rack 26.

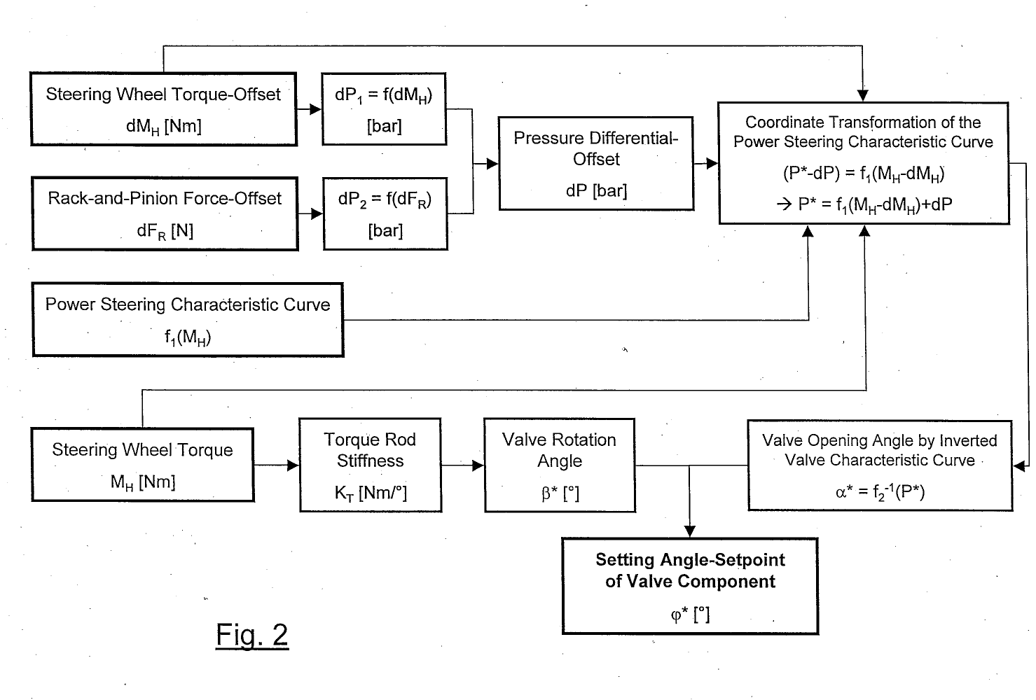

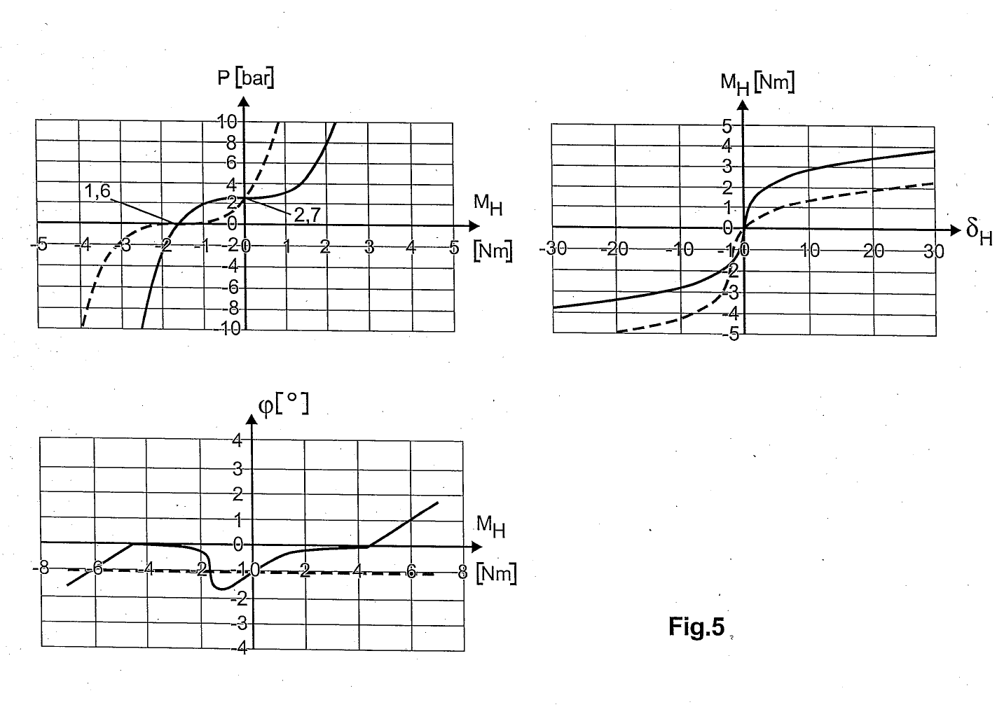

Below, the method to actively trigger the servo valve 12 will be presented in general terms with reference to FIGS. 2 to 4. Then the advantages of the method will be explained in FIGS. 5 to 10 on the basis of concrete examples.

According to the flow diagram in FIG. 2, the method to trigger the servo valve 12 comprises the following steps: by means of a torque sensor 28 (FIG. 1), a steering wheel torque M_{H} that is present on the steering wheel is continuously ascertained. In further steps of the method, a desired rack force offset dF_{R} as well as a desired steering wheel torque offset dM_{H} are specified. Moreover, as an additional input quantity, the desired shape of a power steering characteristic curve f₁(M_{H}) is also specified.

Then a setpoint P* for a differential pressure at a hydraulic cylinder 30 (FIG. 1) of the power steering system is ascertained from the offset values dF_{R}, dM_{H}, the ascertained steering wheel torque M_{H} and from the specified shape of the power steering characteristic curve f₁(M_{H}). As concrete intermediate steps, taking into account the design data of the power steering system, first of all, proportional pressure differential offsets dP₁ and dP₂ are ascertained, the proportional pressure differential offset dP₁ being a function of the steering wheel torque offset dM_{H} and the proportional pressure differential offset dP₂ being a function of the rack force offset dF_{R}. The proportional pressure differential offsets dP₁ and dP₂ are subsequently combined by addition to yield a pressure differential offset dP.

The specified power steering characteristic curve f₁(M_{H}) describes a desired relationship between the steering wheel torque M_{H} and a differential pressure P between working chambers 32 of the hydraulic cylinder 30. The steering wheel torque offset dM_{H} and the pressure differential offset dP now enter into a coordinate transformation of this specified power steering characteristic curve (P=f₁(M_{H})). The result of the coordinate transformation is a new setpoint P* for the differential pressure P at the hydraulic cylinder 30, and the following applies: P*=f₁(M_{H}−dM_{H})+dP.

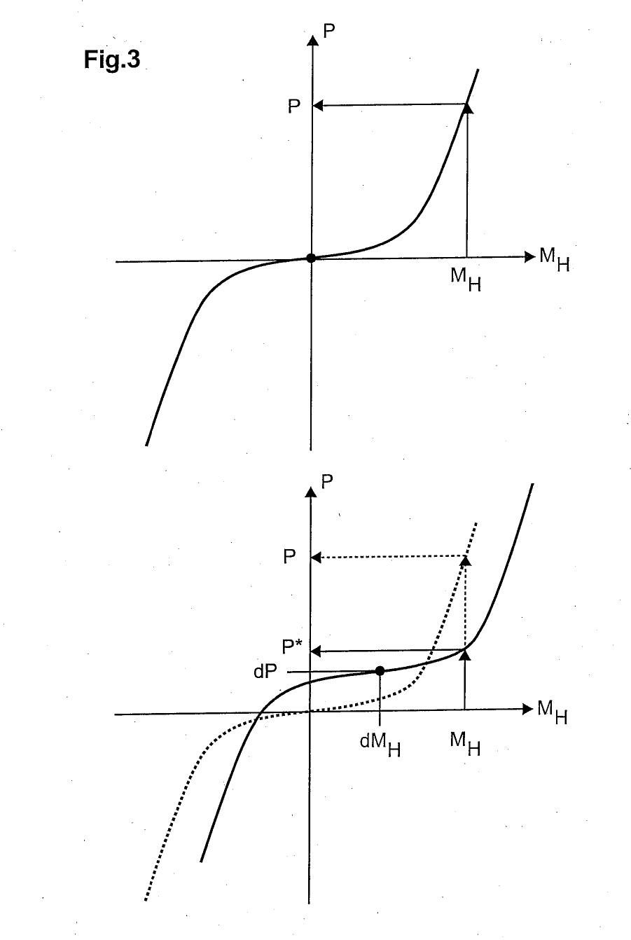

The top of FIG. 3 shows the original power steering characteristic curve f₁(M_{H}) before the coordinate transformation while the bottom of the figure shows the new power steering characteristic curve f₁(M_{H}−dM_{H})+dP. It is clear that the coordinate transformation corresponds to a defined shift of the power steering characteristic curve f₁(M_{H}) while the shape of the characteristic curve is retained.

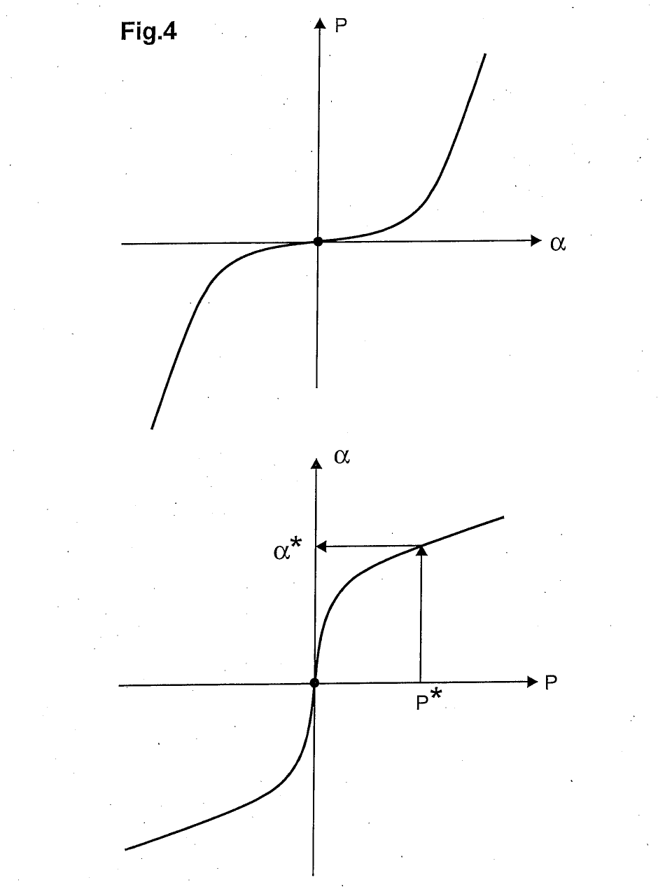

In the next step of the method, a setpoint φ* for the setting angle φ of the valve component is ascertained using the sensed steering wheel torque M_{H} and the ascertained setpoint P* for the differential pressure P at the hydraulic cylinder 30. Concretely speaking, the setting angle φ of the valve component is calculated as the difference between the valve opening angle α and the valve rotation angle β. Here, the valve opening angle α is ascertained by means of an inverted valve characteristic curve f₂⁻¹(P) of the servo valve 12 from the differential pressure P at the hydraulic cylinder 30. The original valve characteristic curve f₂(α) is shown in FIG. 4 (at the top) and indicates the relationship between the valve opening angle α and the differential pressure P at the hydraulic cylinder 30. This relationship is specified by the valve mechanism, that is to say, for instance, by the polished sections of the control grooves. After the inversion of the valve characteristic curve f₂(α) (see FIG. 4 at the bottom), the valve opening angle α* is obtained from the initial value P*. The valve rotation angle β* is ascertained by means of a valve stiffness from the present steering wheel torque M_{H}, and, with the exclusive use of a torque rod for the centering of the servo valve 12, the valve stiffness corresponds to the torque rod stiffness Kₜ (see FIG. 2). Finally, the setpoint φ* for the setting angle φ of the valve component is obtained from the difference between the valve rotation angle β* and the valve opening angle α*.

In a last step of the method, a valve component—in the present case the valve sleeve 22—is rotated relative to the output shaft 20 until the setpoint φ* of the setting angle φ of the valve component is reached.

This method is carried out repeatedly at short intervals, preferably using an electronic control unit 34 of the power steering system (see FIG. 2). The electronic control unit 34 obtains all relevant information (e.g. about the steering wheel torque, vehicle speed, side wind, vehicle stability, etc.) and triggers the drive 16 of the power steering system such that the drive 16 continuously adjusts the setpoint φ* of the setting angle φ of the valve component via the gear 14. In other words, this method achieves a dynamic valve component adjustment as a function of the sensed steering wheel torque M_{H}.

The setting angle φ of the valve component should be set very precisely since even slight deviations between the setpoint φ* and an actual value φ**, i.e. the actually present setting angle φ of the valve component, lead to perceptible changes in the hydraulic steering assistance. In order to attain a more precise rotation of the valve component, the simple open-loop control of the setting angle φ of the valve component can be replaced by a closed-loop control of the setting angle φ of the valve component involving an adjustment of the setpoint and of the actual value. For this purpose, the servo valve 12 according to FIG. 1 has a sensor 36 with which an actual value φ** of the setting angle φ of the valve component is measured. Moreover, a valve component position regulator 38 is provided that is connected to the sensor 36 and that readjusts the rotation of the valve component via the drive 16 and the gear 14 in such a way that the measured actual value φ** matches the setpoint φ* of the setting angle φ of the valve component. The position regulator 38 here is preferably integrated into the electronic control unit 34. Thanks to the described detection and feedback of the actual value φ** to the electronic control unit 34, the setting angle φ of the valve component can be adjusted extremely precisely.

Below, a known, static valve component adjustment and the dynamic valve component adjustment described above will be compared by way of an example, making reference to three special cases; the diagram curves of the static valve component adjustment are each shown with a broken line and the diagram curves of the dynamic valve component adjustment are each drawn as a solid line.

FIG. 5 shows a first special case in which the desired steering wheel torque offset dM_{H}=0, and the desired shape of the power steering characteristic curve f₁(M_{H}) matches the basic shape of the power steering characteristic curve at a constant valve component setting angle φ of 0°. The desired rack force offset dF_{R} is specified at 400 N (for example, in order to compensate for a virtually static side wind force). Taking into account the design data of the power steering system, the rack force offset dF_{R} of 400 N corresponds to a pressure differential offset dP of about 2.7 bar. In order to obtain a differential pressure P of 2.7 bar in the power steering characteristic curve f₁(M_{H}) (FIG. 5, top left) at a steering wheel torque M_{H} of 0 Nm, a static valve component adjustment with a setting angle φ of the valve component of about −1° can be carried out (FIG. 5, lower left, broken line). As a result, the power steering characteristic curve f₁(M_{H}) shifts by 1.6 Nm to the left and intersects the ordinate at 2.7 bar. As an alternative, a dynamic valve component adjustment φ(M_{H}) is carried out by means of the method according to the invention (FIG. 5, lower left, solid line), as a result of which the power steering characteristic curve f₁(M_{H}) is shifted upwards to such an extent that it likewise intersects the ordinate at a differential pressure P of 2.7 bar.

The advantage of the dynamic valve component adjustment can be seen in the depiction of the steering torque gradient (FIG. 5, top right) in which the steering wheel torque M_{H} is plotted over a steering wheel angle δ_{H} (when the vehicle is driving straight ahead: δ_{H}=0). In case of the static valve component adjustment, the steering wheel torque M_{H} increases only slightly when the vehicle is turned to the right (δ_{H}>0) because the operating point of the servo valve 12 has already been shifted far into the area of large gradients of the power steering characteristic curve f₁(M_{H}). In contrast, when the vehicle is turned to the left (δ_{H}<0), the magnitude of the steering wheel torque M_{H} increases steeply because the operating point of the servo valve 12 first has to pass through the deadband of the power steering characteristic curve f₁(M_{H}) and, only in the case of steering wheel torque changes of a large magnitude does the operating point move back into the range of perceptible steering force assistance. This behavior of the power steering system with the specified setting angle φ of the valve component has a very negative effect on the driver's steering feel. This becomes clear from the example of a virtually static side wind force. Using the static valve sleeve adjustment, the static rack force portion F_{R} caused by the force of the side wind can be completely compensated for, but when the driver turns the steering wheel out of the centre position and against the force of the side wind, he feels almost no increase in the steering wheel torque M_{H}, whereas the steering wheel torque M_{H} increases severely when the steering wheel is turned away from the side wind. This behavior of the power steering system contradicts the expectation of the driver since, when the driver steers out of the centre position, the magnitude of the steering wheel torque M_{H} increases approximately to the same extent in both directions. This expectation is fulfilled by the dynamic valve component adjustment (FIG. 5, top right, solid curve).

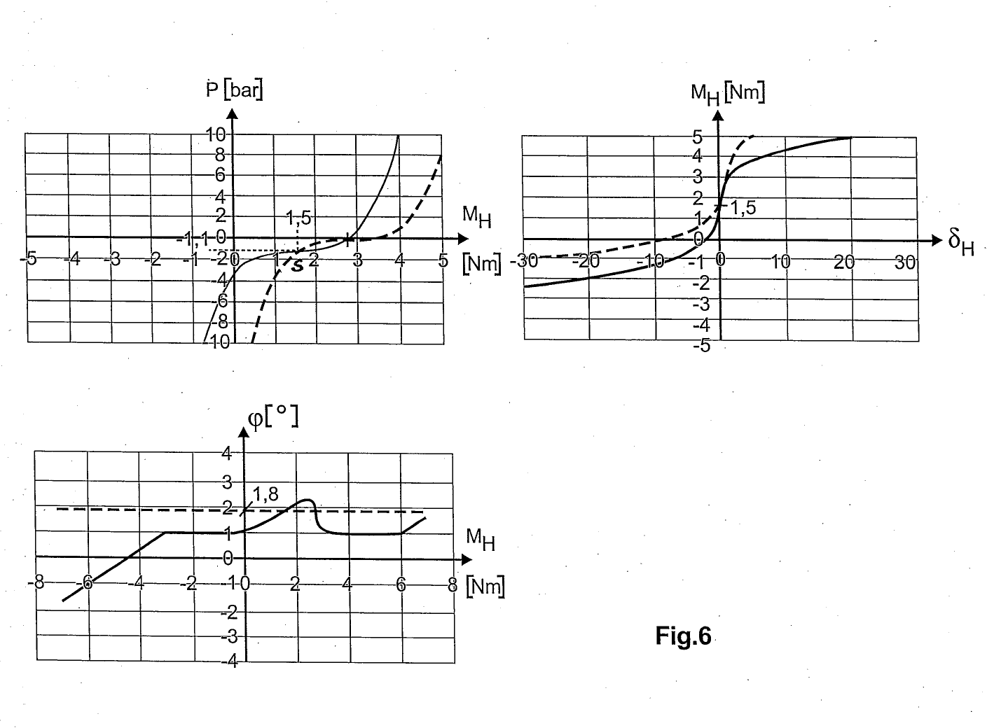

FIG. 6 shows a second special case in which the rack force offset dF_{R}=0, and the desired shape of the power steering characteristic curve f₁(M_{H}) matches the basic shape of the power steering characteristic curve at a constant valve component setting angle φ of 0°. In the present example, the desired steering wheel torque offset dM_{H} is specified as 1.5 Nm. Such a steering wheel torque offset dM_{H} gives the driver, for example, an active steering assistance impulse, i.e. haptic information that conveys to him a steering correction for the stabilization of the vehicle.

Analogous to the specification of a rack force offset dF_{R}, an externally generated setting angle φ of the valve component causes a first valve deflection which results in a pressure differential P at the hydraulic cylinder 30, also when a steering wheel torque offset dM_{H} is specified. The pressure differential P at the hydraulic cylinder 30 generates a rack force F_{R} that is now not compensated for like in the first example directly by a side wind force but rather by a steering wheel torque M_{H} that has to be applied by the driver. This steering wheel torque M_{H} twists the torque rod of the servo valve 12 which, in turn, leads to a second valve deflection that is, however, oriented in the opposite direction from the first valve deflection. The resultant valve deflection is thus much smaller than would correspond to the setting angle φ of the valve component without taking into account the feedback from the twisting of the torque rod. This difference between the specification of a rack force offset dF_{R} and the specification of a steering wheel torque offset dM_{H} is taken into account for the coordinate transformation.

In the present case, it is concretely desired that, at a steering wheel angle δ_{H}=0 (driving straight ahead), a steering wheel torque M_{H} of 1.5 Nm should be perceptible (FIG. 6, top right). Taking into account the design data of the power steering system and the above-mentioned feedback from the rotation of the torque rod, the driver has to compensate for a differential pressure P at the hydraulic cylinder 30 of about −1.1 bar through a steering wheel torque M_{H} of 1.5 Nm. Due to a static valve component adjustment with a setting angle φ of the valve component of approximately 1.8° (FIG. 6, lower left, broken curve), the power steering characteristic curve f₁(M_{H}) is shifted by 2.7 Nm to the right, so that a differential pressure P of −1.1 bar is established at a steering wheel torque M_{H} of 1.5 Nm (FIG. 6, top left, broken curve). As an alternative, a dynamic valve component adjustment φ(M_{H}) is carried out by the method according to the invention (FIG. 6, lower left, solid curve), as a result of which the power steering characteristic curve f₁(M_{H}) is shifted diagonally such that it likewise runs through the Point S (1.5 Nm/−1.1 bar) (FIG. 6, upper left, solid curve).

Like in the first example according to FIG. 5, the advantage of the dynamic valve component adjustment also becomes clear here when the steering torque gradients are considered (FIG. 6, top right). In the centre position of the steering wheel, the steering wheel torque M_{H} is 1.5 Nm in both cases, corresponding to the selected setpoint for the steering wheel torque offset dM_{H}. In the broken curve resulting from a static valve component adjustment, the steering wheel torque M_{H} changes only slightly when the vehicle is turned to the left (δ_{H}<0), because the operating point of the servo valve 12 remains in the area of large gradients of the power steering characteristic curve f₁(M_{H}). In contrast, when the vehicle is turned to the right (δ_{H}>0), the magnitude of the steering wheel torque M_{H} increases steeply because the operating point of the servo valve 12 first has to pass through the deadband of the power steering characteristic curve f₁(M_{H}) once again. Consequently, in the case of the active influencing of the steering wheel torque M_{H}, the steering behavior of the power steering system with the specified setting angle φ of the valve component is not satisfactory either. The reason is that taking a steering wheel torque offset dM_{H} into account is associated with an undesired change in the steering torque gradient of the power steering system when the vehicle is turned out of the centre position. Analogously to the first example, this shortcoming can be remedied by a dynamic valve component adjustment (FIG. 6, solid curves).

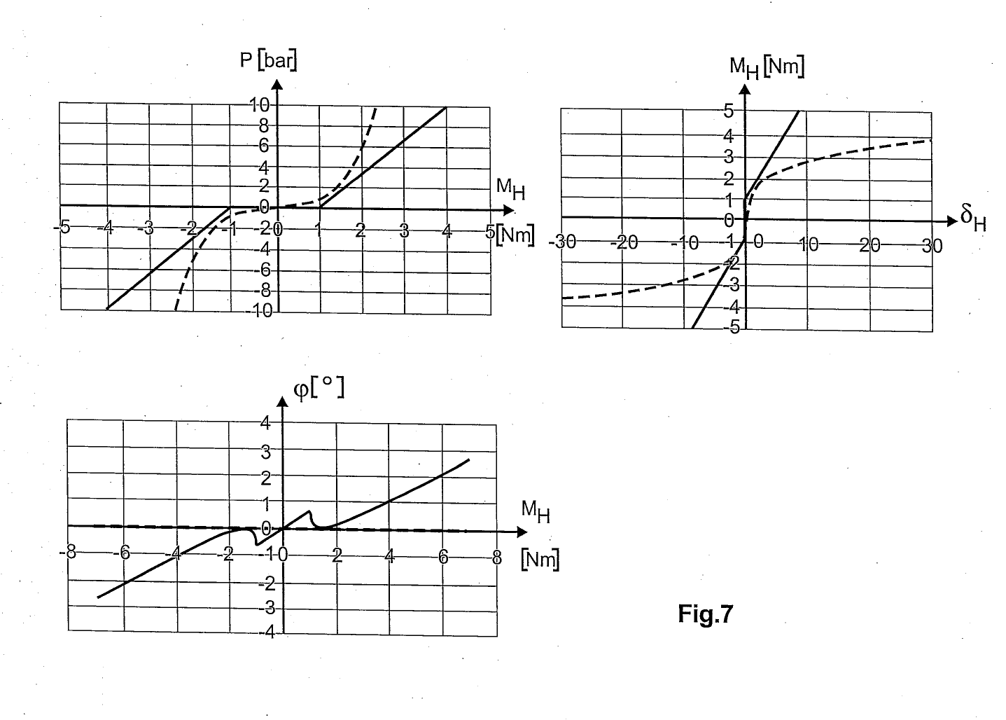

Finally, FIG. 7 shows a special case of the method in which the steering wheel torque offset dM_{H} as well as the rack force offset dF_{R} are both specified as being 0 and only the shape of the power steering characteristic curve f₁(M_{H}) is freely defined by the dynamic valve component adjustment. At the top left of FIG. 7, the original basic shape of the power steering characteristic curve f₁(M_{H}) is shown by a broken line. This power steering characteristic curve f₁(M_{H}) is obtained at a constant valve component setting angle φ of 0° (FIG. 7, lower left, broken curve). In some cases, it can be advantageous to change the basic shape of the power steering characteristic curve f₁(M_{H}) into any desired freely defined shape, for example, into a course that is linear in sections, which is shown in FIG. 7 (upper left) as a solid line. For this purpose, a dynamic valve component adjustment is necessary, i.e. an active setting of the setting angle φ of the valve component as a function of the present steering wheel torque M_{H} according to FIG. 7 (lower left, solid line). In this manner, for example, various shapes of the power steering characteristic curve that are especially advantageous for a particular speed can be defined as a function of the vehicle speed. The effects on the steering torque gradients are likewise shown in FIG. 7 (upper right).

For the sake of easier understanding, the examples according to FIGS. 5 to 7 are special cases in which only either a rack force offset dF_{R} or a steering wheel torque offset dM_{H} or a shaping of the power steering characteristic curve f₁(M_{H}) is present. Of course, the claimed method also comprises cases in which the special cases presented overlap in any desired manner.

The described method to actively trigger a servo valve also has an advantageous effect on the production of the valve. Until now, the desired power steering characteristic curve f₁(M_{H}) has been achieved by a change in the valve characteristic curve f₂(α), that is to say, for example, through different polished sections on the control grooves of the input shaft 18. If the power steering characteristic curve f₁(M_{H}) does not lie within a specified tolerance range during a subsequent test of the servo valve 12 on the test bench, then the servo valve 12 has to undergo labor-intensive reworking or else it has to be viewed as a reject.

With the described method, the power steering characteristic curve f₁(M_{H}) can be adapted to a desired course, even though the valve characteristic curve f₂(α) is not changed. Hence, for one thing, complex production steps such as the polishing of control grooves can be dispensed with and secondly, the reject rates can be lowered.

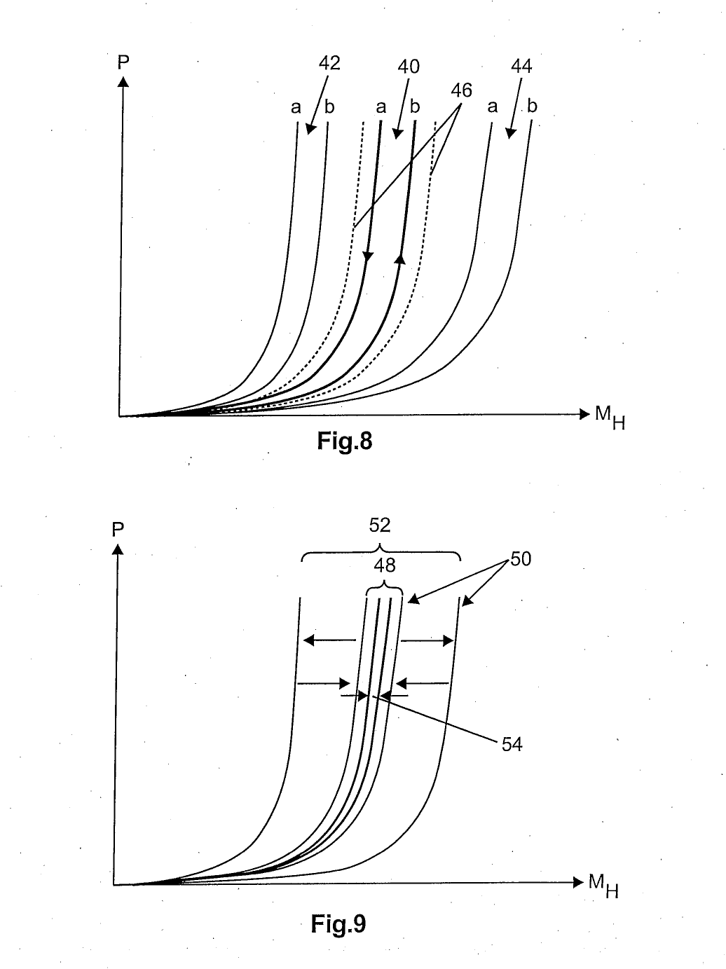

As can be seen in FIG. 8, a power steering characteristic curve 40 follows different curve segments 40a, 40b when the steering wheel torque M_{H} increases and decreases. This hysteresis is caused by the mechanical friction in the steering system. Using the dynamic valve component adjustment, the power steering characteristic curves 42, 44, which lie outside of a tolerance range 46, can be shifted and/or shaped with very little effort such that they finally come to lie within the tolerance range 46 (see power steering characteristic curve 40).

In an especially preferred manner, the desired power steering characteristic curve 40, like the valve characteristic curve f₂(α), is stored in the electronic control unit 34 of the vehicle. As a function of the present steering wheel torque M_{H}, the control unit 34 uses this curve to calculate a setting angle φ of the valve component so that, all in all, the desired power steering characteristic curve 40 is obtained (see, for instance, FIG. 7, lower left).

It is also possible to always produce an identical, uniform valve characteristic curve for various vehicle projects that has a typical course with a moderate pitch, and to then adapt it to the requirement of each manufacturer for the particular vehicle by means of active valve triggering. In this manner, the time-consuming and costly development of the “right” grinding of the control edges can be dispensed with, which would otherwise be necessary in order to achieve the valve characteristic curve required by the manufacturer.

Instead of the entire power steering characteristic curve 42, 44, it is also possible to only adapt individual curve segments 42a, 42b, 44a, 44b in order to correct a hysteresis that is too narrow or too wide. In particular, by appropriately triggering the servo valve 12, it is also possible to compensate for the phenomenon of dynamic hysteresis increase, which occurs during the operation of the steering system at high steering angle speeds (see FIG. 9). As a result of this phenomenon, a hysteresis 48 of a power steering characteristic curve 50 widens in an undesired manner during the operation of the power steering system (hysteresis 52). For example, soft hose lines contribute to a high dynamic hysteresis. Owing to the large hydraulic capacity of such hose lines, they lead to a delayed pressure change in the hydraulic system and thus to a soft, indirect steering feel. At the same time, however, they also reduce undesired system fluctuations and the associated noises. Through a suitable triggering of the servo valve 12, the power steering characteristic curve 50 can now be set with a minimal hysteresis, even though soft and thus noise-optimized hose lines are installed.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A method to actively trigger a servo valve of a hydraulic power steering system, comprising the following steps:
(a) ascertaining a present steering wheel torque with a sensor;
(b) specifying a desired rack-and-pinion force offset;
(c) specifying a desired steering wheel torque offset;
(d) specifying a desired shape of a power steering characteristic curve;
(e) ascertaining a setpoint for a differential pressure at a hydraulic cylinder of the power steering system based on the desired rack-and-pinion force offset, the desired steering wheel torque offset, the present steering wheel torque, and the shape of the power steering characteristic curve;
(f) ascertaining a setpoint for a setting angle of a valve component based on the steering wheel torque and on the setpoint for the differential pressure at the hydraulic cylinder; and
(g) rotating an appropriate valve component of the servo valve until the setpoint of the setting angle of the valve component is reached.

2. The method according to claim 1 wherein step (e) includes the step of:
carrying out a coordinate transformation of the specified power steering characteristic curve using the desired rack-and-pinion force offset and the desired steering wheel torque offset and the ascertained steering wheel torque to yield the setpoint for the differential pressure at the hydraulic cylinder of the power steering system.

3. The method according to claim 2 further comprising the step of:
ascertaining a pressure differential offset for the hydraulic cylinder of the power steering system based on the specified rack-and-pinion force offset and the specified steering wheel torque offset; and
wherein said carrying out step includes the step of entering the pressure differential offset into the coordinate transformation of the specified power steering characteristic curve.

4. The method according to claim 1, wherein the setpoint of the setting angle of the valve component is calculated in step f) as the difference between a valve opening angle and a valve rotation angle, the valve opening angle being ascertained by means of an inverted valve characteristic curve of the servo valve on the basis of the setpoint for the differential pressure at the hydraulic cylinder, and the valve rotation angle being ascertained by means of a valve stiffness on the basis of the present steering wheel torque.

5. The method according to claim 1, wherein the desired shape of the power steering characteristic curve in step d) corresponds to a basic shape of the power steering characteristic curve at a constant valve component setting angle of 0°.

6. The method according to claim 1, wherein the desired shape of the power steering characteristic curve is freely defined in step d), as a result of which a relationship between the present steering wheel torque and the differential pressure at the hydraulic cylinder is specified, said relationship then entering into the calculation of the setpoint for the differential pressure at the hydraulic cylinder in step e).

7. The method according to claim 1, wherein the valve component that is rotated in step g) is a valve sleeve of the servo valve.

8. The method according to claim 1, wherein the servo valve comprises an input shaft, an output shaft that is rotatable relative to the input shaft, and a valve sleeve that is rotatable relative to the output shaft, an angle between the valve sleeve and the output shaft corresponding to the setting angle of the valve component.

9. The method according to claim 8, wherein the valve sleeve and the output shaft are coupled by a drive that continuously sets the setpoint for the setting angle of the valve component.

10. The method according to claim 1, wherein a sensor is provided with which an actual value of the setting angle of the valve component is measured.

11. The method according to claim 10, wherein a position regulator is provided that readjusts the rotation of the valve component such that the measured mactual value corresponds to the setpoint of the setting angle of the valve component.
